(19) United States
(12) Patent Application Publication
(10) Pub. No.: US 2024/0304375 A1
(43) Pub. Date: Sep. 12, 2024

(54) INDUCTOR COMPONENT

(71) Applicant: Murata Manufacturing Co., Ltd., Kyoto-fu (JP)

(72) Inventors: Yoshimasa YOSHIOKA, Nagaokakyo-shi (JP); Kenji TOYOSHIMA, Nagaokakyo-shi (JP); Katsufumi SASAKI, Nagaokakyo-shi (JP)

(73) Assignee: Murata Manufacturing Co., Ltd., Kyoto-fu (JP)

(21) Appl. No.: 18/595,854

(22) Filed: Mar. 5, 2024

(30) Foreign Application Priority Data
Mar. 6, 2023 (JP) 2023-033659

(51) Int. Cl. H01F 27/28; H01F 1/08; H01F 27/02; H01F 27/32

(52) U.S. Cl. CPC H01F 27/2828; H01F 1/083; H01F 27/022; H01F 27/327

(57) ABSTRACT

An inductor component includes a rectangular parallelepiped element body having a main surface, an inductor wiring, and columnar wirings. The inductor wiring includes a pair of pad portions and a wiring main body that connects the pair of pad portions to each other. When the element body is viewed through in a direction orthogonal to the main surface, a specific pad portion, which is one of the pair of pad portions, is adjacent to an outer edge of the main surface without other parts of the inductor wiring therebetween. In addition, when the element body is viewed through in the direction orthogonal to the main surface, among four corner portions of the main surface, the corner portion closest to the specific pad portion is defined as a specific corner portion.

### CROSS-REFERENCE TO RELATED APPLICATION

This application claims benefit of priority to Japanese Patent Application No. 2023-033659, filed Mar. 6, 2023, the entire content of which is incorporated herein by reference.

### BACKGROUND

### Technical Field

The present disclosure relates to an inductor component.

### Background Art

An inductor component described in Japanese Unexamined Patent Publication No. 2022-123120 includes an element body having a main surface, a pair of outer electrodes, and an inductor wiring. The element body has a rectangular parallelepiped shape. One of the outer electrodes covers a first side surface orthogonal to the main surface among the six outer surfaces of the element body. The other outer electrode covers a second side surface opposite to the first side surface. The inductor wiring extends parallel to the main surface inside the element body. The two end portions of the inductor wiring are connected to the outer electrode at the geometric center of the first side surface and the second side surface, respectively.

### SUMMARY

In the inductor component as described in Japanese Unexamined Patent Publication No. 2022-123120, the inductor wiring extends to connect from the geometric center of a first end surface to the geometric center of a second end surface. As described above, under the limitation that the positions of both ends of the inductor wiring match the geometric center of each end surface, there is a limit in trying to lengthen the wiring length of the inductor wiring. Therefore, in order to lengthen the wiring length of the inductor wiring, it is necessary to take a countermeasure such as increasing the size of the element body itself, which is not preferable.

Accordingly, the present disclosure provides an inductor component including a rectangular parallelepiped element body containing a magnetic material and having a planar main surface; an inductor wiring extending parallel to the main surface in the element body; and a plurality of columnar wirings extending in a direction intersecting with the main surface. The inductor wiring includes a pair of pad portions which are positioned at both end portions of the inductor wiring, and to which the columnar wiring is connected, and a wiring main body which connects the pair of pad portions to each other. When the element body is viewed through in a direction orthogonal to the main surface, a specific pad portion, which is one of the pair of pad portions, is adjacent to an outer edge of the main surface without other parts of the inductor wiring therebetween. Also, when the element body is viewed through in the direction orthogonal to the main surface, and, among four corner portions of the main surface, the corner portion closest to the specific pad portion is defined as a specific corner portion, a shortest distance from the specific corner portion to an outer edge of the specific pad portion is less than a shortest distance from any corner portion excluding the specific corner portion to the wiring main body.

According to the above configuration, the shortest distance from the specific corner portion to the outer edge of the specific pad portion is less than the shortest distance from any corner portion excluding the specific corner portion to the wiring main body. As described above, since the specific pad portion is disposed closer to the specific corner portion, the shape of the wiring main body can be designed without limiting the position of the pad portion. That is, since the degree of freedom in the design of the wiring main body can be improved, the wiring length of the inductor wiring can be designed to be long. Further, since a sufficient distance is ensured as the distance from any corner portion excluding the specific corner portion to the wiring main body, a magnetic path in the vicinity of the corner portion can be sufficiently ensured. From the above, it is easy to acquire a large value as the inductance value of the inductor component.

It is easy to acquire a large value as the inductance value of the inductor component.

### BRIEF DESCRIPTION OF THE DRAWINGS

FIG. 1 is a perspective view of an inductor component;

FIG. 2 is a side view of the inductor component;

FIG. 3 is a cross-sectional view of the inductor component taken along line 3-3 in FIG. 2;

FIG. 4 is a cross-sectional view of the inductor component taken along line 4-4 in FIG. 2;

FIG. 5 is a cross-sectional view of the inductor component taken along line 5-5 in FIG. 2;

FIG. 6 is a cross-sectional view of an inductor component of a modification example;

FIG. 7 is a cross-sectional view of an inductor component of a modification example; and

FIG. 8 is a cross-sectional view of the inductor component of the modification example.

### DETAILED DESCRIPTION

Hereinafter, an inductor component will be described. In the drawings, constituent elements may be enlarged and illustrated for easy understanding. The dimensional ratio of constituent elements may be different from the actual ones or from those in other drawings.

### Regarding Overall Configuration

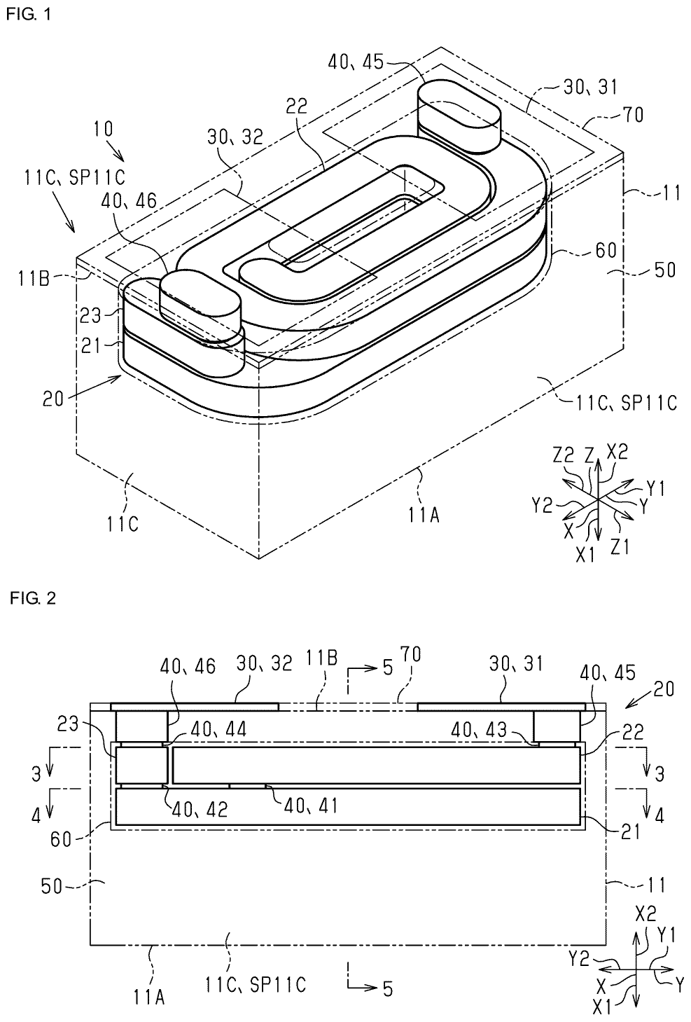

As illustrated in FIG. 1, an inductor component 10 has a substantially rectangular parallelepiped shape as a whole. The inductor component 10 includes an element body 11, three inductor wirings 20 extending inside the element body 11, two outer electrodes 30 exposed from the element body 11, six columnar wirings 40, and an insulating layer 60.

The element body 11 has six planar outer surfaces. A specific one surface among the six outer surfaces is defined as a main surface 11A. In addition, a surface positioned on the side opposite to the main surface 11A and parallel to the main surface 11A is defined as a mounting surface 11B. Further, four surfaces perpendicular to the main surface 11A are defined as side surfaces 11C. The outer shape of the main surface 11A, the outer shape of the mounting surface 11B, and the outer shape of the four side surfaces 11C are all rectangular.

Here, an axis perpendicular to the main surface 11A is defined as a first axis X. In addition, an axis orthogonal to the first axis X and parallel to a specific side of the main surface 11A, which is a long side of the main surface 11A in the present embodiment, is defined as a second axis Y. Further, an axis perpendicular to the first axis X and the second axis Y is defined as a third axis Z. In addition, a direction in which the main surface 11A faces, among the directions along the first axis X, is defined as a first positive direction X1, and a direction opposite to the first positive direction X1 is defined as a first negative direction X2. In addition, a specific one direction among the directions along the second axis Y is defined as a second positive direction Y1, and a direction opposite to the second positive direction Y1 is defined as a second negative direction Y2. Further, a specific one direction among the directions along the third axis Z is defined as a third positive direction Z1, and a direction opposite to the third positive direction Z1 is defined as a third negative direction Z2.

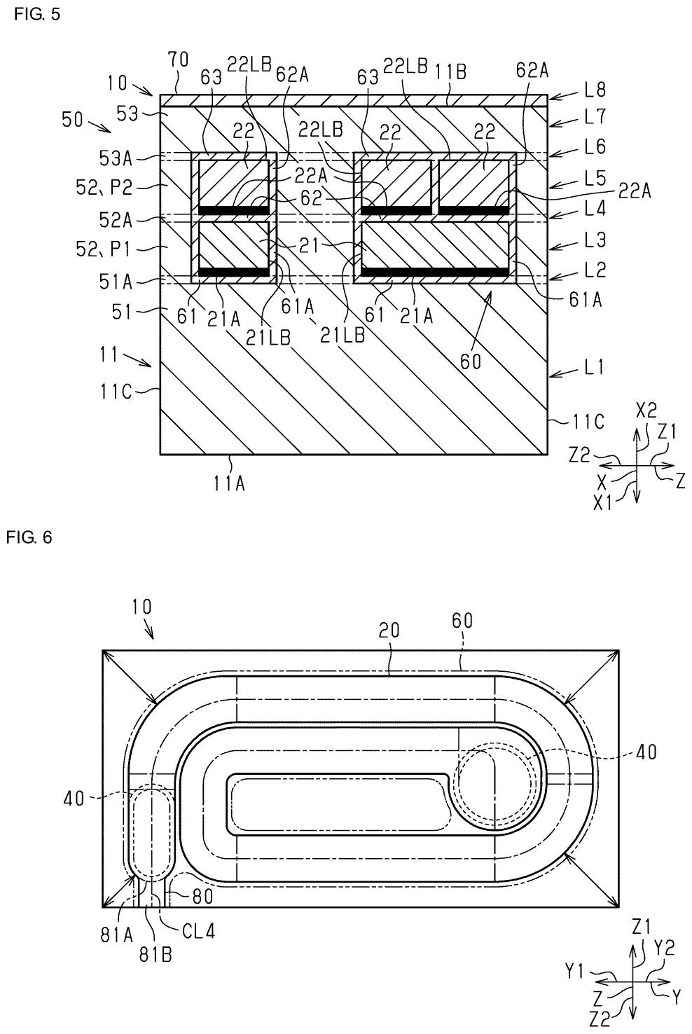

As illustrated in FIG. 5, the element body 11 includes a first magnetic layer 51, a second magnetic layer 52, a third magnetic layer 53, a first interlayer magnetic layer 51A, a second interlayer magnetic layer 52A, and a third interlayer magnetic layer 53A, as a magnetic layer 50. The material of the magnetic layer 50 is an organic resin containing a metal magnetic powder. That is, the element body 11 contains a magnetic material. In this embodiment, the metal magnetic powder is a metal magnetic powder made of an Fe-based alloy or an amorphous alloy. More specifically, the metal magnetic powder is an FeSiCr-based metal powder containing iron. The metal magnetic powder is not limited to, for example, FeSiCr-based magnetic powder, but may be FeCo-based, FeSiAr-based, iron oxide-based, and a combination thereof. In addition, the organic resin may be epoxy, imide, liquid crystal polymer, acrylic, phenol, or a combination thereof. In addition, in the organic resin, an inorganic filler may be mixed in addition to the above-described materials.

In addition, the median particle size (D50) in the particle size distribution of the metal magnetic powder is equal to or less than one tenth with respect to the shortest distance from the inductor wiring 20 to the outer edge of the main surface 11A when the element body 11 is viewed through in the direction orthogonal to the main surface 11A. The median particle size (D50) of the metal magnetic powder is calculated, for example, as follows. First, a metal magnetic powder is sampled by a scanning electron microscope (SEM) to acquire a particle size distribution. Next, in the particle size distribution, the frequency of the particle sizes is integrated from the smallest particle size to the large particle size. The particle size when the integrated value becomes 50% is defined as a median particle size (D50).

As illustrated in FIG. 2, the inductor wiring 20 includes a first inductor wiring 21, a second inductor wiring 22, and a connection wiring 23. The material of each inductor wiring 20 is a conductive material. In the present embodiment, the composition of the inductor wiring 20 is, for example, a copper ratio of 99% by weight or higher and a sulfur ratio of 0.1% by weight or higher and 1.0% by weight or lower (i.e., from 0.1% by weight to 1.0% by weight). The inductor wiring 20 is not limited to a conductor having copper as a main component, and may be a conductor having Ag, Al, and Au as main components.

The first inductor wiring 21, the second inductor wiring 22, and the connection wiring 23 extend parallel to the main surface 11A in the element body 11. The second inductor wiring 22 and the connection wiring 23 are positioned at a location different from the first inductor wiring 21 in a direction orthogonal to the main surface 11A. In addition, the second inductor wiring 22, the first inductor wiring 21, and the connection wiring 23 are connected in series in this order.

The outer electrode 30 includes a first outer electrode 31 and a second outer electrode 32. Each of the outer electrodes 30 is positioned on the mounting surface 11B of the element body 11. That is, each of the outer electrodes 30 covers a part of the outer surface of the element body 11.

The first outer electrode 31 is positioned on the mounting surface 11B on the second positive direction Y1 side with respect to the geometric center of the mounting surface 11B. The second outer electrode 32 is positioned on the mounting surface 11B on the second negative direction Y2 side with respect to the geometric center of the mounting surface 11B.

Each columnar wiring 40 extends in the direction intersecting with the main surface 11A. In the present embodiment, each columnar wiring 40 extends in the direction orthogonal to the main surface 11A. Each columnar wiring 40 connects the first inductor wiring 21, the second inductor wiring 22, the connection wiring 23, and each of the outer electrodes 30 in the direction along the first axis X.

As illustrated in FIG. 5, the inductor component 10 includes a first insulating layer 61, a second insulating layer 62, a third insulating layer 63, a first side surface insulating layer 61A, and a second side surface insulating layer 62A, as the insulating layer 60. The material of the insulating layer 60 is an insulating resin. In this embodiment, for example, a polyimide resin is used.

As illustrated in FIG. 5, the inductor component 10 has a structure in which eight layers are laminated in the direction along the first axis X as a whole. The layer structure of the inductor component 10 is formed by manufacturing the inductor component 10 by a semi-additive process (SAP). The inductor component 10 of the present embodiment is formed in order from a first layer L1 to an eighth layer L8. The SAP can be manufactured according to, for example, a known manufacturing method as described in Japanese Unexamined Patent Publication No. 2020-136467.

The first layer L1 is formed of the first magnetic layer 51. The surface of the first magnetic layer 51 on the first positive direction X1 side is the main surface 11A. In the present embodiment, the dimension in the direction orthogonal to the main surface 11A of the first layer L1 is 230 μm.

The second layer L2 is laminated on the surface of the first layer L1 on the first negative direction X2 side. In the present embodiment, the dimension of the second layer L2 in the direction orthogonal to the main surface 11A is 10 μm. The second layer L2 includes the first insulating layer 61 and the first interlayer magnetic layer 51A. The first insulating layer 61 is laminated on a part of the surface of the first layer L1 on the first negative direction X2 side. The formation region of the first insulating layer 61 corresponds to the positions of the first inductor wiring 21 and the first side surface insulating layer 61A, which will be described later. The first interlayer magnetic layer 51A configures a part of the second layer L2 other than the first insulating layer 61.

The third layer L3 is laminated on the surface of the second layer L2 on the first negative direction X2 side. In the present embodiment, the dimension of the third layer L3 in the direction orthogonal to the main surface 11A is 70 μm. The third layer L3 includes the first inductor wiring 21, the first side surface insulating layer 61A, and a first part P1 of the second magnetic layer 52.

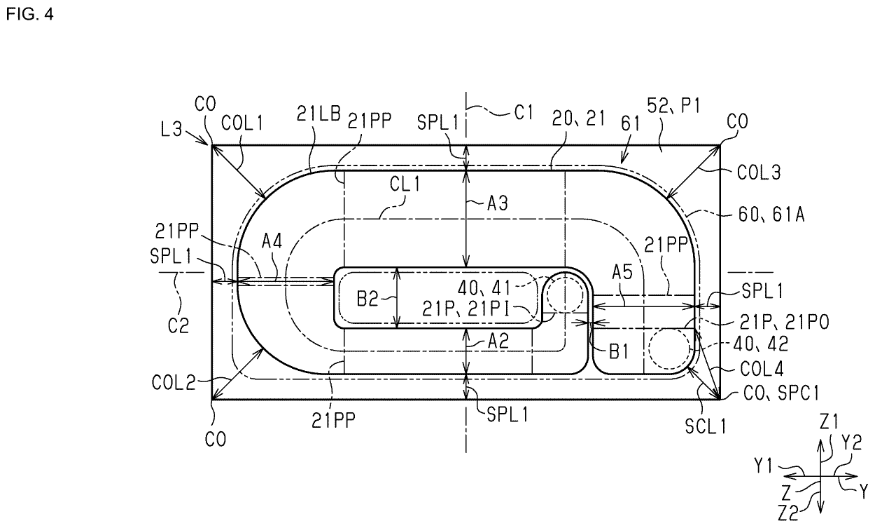

As illustrated in FIG. 4, the first inductor wiring 21 extends parallel to the main surface 11A and in a spiral shape. When viewed through toward the first positive direction X1 side, the first inductor wiring 21 is positioned within the range of the first insulating layer 61. As illustrated in FIG. 5, the first inductor wiring 21 includes a first seed layer 21A. The first seed layer 21A is disposed on the surface of the first insulating layer 61 on the side that faces the first negative direction X2. The first seed layer 21A is in contact with the first insulating layer 61. The material of the first seed layer 21A is copper. By performing electrolytic copper plating on the first seed layer 21A, copper grows on the first seed layer 21A, and the entire first inductor wiring 21 is formed. As described above, the first inductor wiring 21 is disposed on the surface of the first insulating layer 61 of the second layer L2 opposite to the main surface 11A. Further, in other words, the first magnetic layer 51 is positioned on the main surface 11A side of the first inductor wiring 21.

As illustrated in FIG. 4, the first inductor wiring 21 includes a pair of first pad portions 21P and a first wiring main body 21LB. The pair of first pad portions 21P are positioned at both end portions of the first inductor wiring 21. One of the pair of first pad portions 21P is defined as a first inner side pad portion 21PI. The remaining one of the pair of first pad portions 21P is defined as a first outer side pad portion 21PO. The first inner side pad portion 21PI is positioned on the second negative direction Y2 side and the third negative direction Z2 side with respect to the geometric center of the third layer L3 when viewed through in the first positive direction X1. The first outer side pad portion 21PO is further positioned on the second negative direction Y2 side and the third negative direction Z2 side with respect to the first inner side pad portion 21PI.

The first wiring main body 21LB connects the pair of first pad portions 21P to each other. Specifically, when the third layer L3 is viewed in the first positive direction Xl, the first wiring main body 21LB extends such that the diameter increases as the number of turns increases clockwise from the first inner side pad portion 21PI toward the first outer side pad portion 21PO. The number of turns of the first inductor wiring 21 is 1.0.

The number of turns of the first inductor wiring 21 is determined based on the virtual vector. The starting point of the virtual vector is disposed on a center line CL1 of the first inductor wiring 21. Then, regarding the virtual vector, when the starting point is moved from the state of being disposed at the first end of the center line CL1 to the second end of the center line CL1 when viewed in the first negative direction X2, when the angle by which the orientation of the virtual vector is rotated is 360 degrees, the number of turns is determined as 1.0. However, when the orientation of the virtual vector is wound a plurality of times, or when the winding is continuous in the same direction, the number of turns increases.

Further, the center line of the inductor wiring 20 is defined as follows. The shortest line segment is specified among line segments that can be drawn from any point on the edge of the inductor wiring 20 to the opposite edge thereof when viewed through in the first positive direction X1. A line connecting points passing through the centers of the specified line segments is defined as the center line of the inductor wiring 20 when viewed through in the first positive direction X1. The center line CL1 of the first wiring main body 21LB matches the center line CL1 of the first inductor wiring 21. In the present embodiment, the center line CL1 of the first wiring main body 21LB will also be given the same reference numeral as the center line CL1 of the first inductor wiring 21.

In addition, a boundary line between the first wiring main body 21LB and the first pad portion 21P when viewed through in the first positive direction X1 is defined as a virtual line orthogonal to the center line CL1. Specifically, when viewed through in the first positive direction X1, a point in the outer edge of the columnar wiring 40 closest to the first wiring main body 21LB side is specified. A virtual line tangent to the specified point and orthogonal to the center line CL1 is defined as a boundary line between the first wiring main body 21LB and the first pad portion 21P. The part of the first inductor wiring 21 on the side that includes the columnar wiring 40 from the boundary line is the first pad portion 21P.

As illustrated in FIG. 5, among the outer surfaces of the first inductor wiring 21, a surface excluding a surface that faces the first positive direction X1 and a surface that faces the first negative direction X2 is defined as the side surface of the first inductor wiring 21. The first side surface insulating layer 61A covers the entire side surfaces of the first inductor wiring 21. In addition, when viewed in the first positive direction X1, the first side surface insulating layer 61A is positioned within the range of the first insulating layer 61 in the second layer L2.

The first part P1 configures a part of the third layer L3 excluding the first inductor wiring 21 and the first side surface insulating layer 61A. That is, the first part P1 is a part of the element body 11 in the same layer as the first inductor wiring 21 in the direction orthogonal to the main surface 11A. In addition, when viewed in the first positive direction X1, the first side surface insulating layer 61A is positioned within the range of the first insulating layer 61 in the second layer L2.

As illustrated in FIG. 5, a fourth layer L4 is laminated on the surface of the third layer L3 on the first negative direction X2 side. In the present embodiment, the dimension of the fourth layer L4 in the direction orthogonal to the main surface 11A is 10 μm. The fourth layer L4 includes two columnar wirings 40, the second insulating layer 62, and the second interlayer magnetic layer 52A.

As illustrated in FIG. 2, the two columnar wirings 40 on the fourth layer L4 are a first via 41 and a second via 42. The first via 41 has a columnar shape. The material of the first via 41 is the same as the material of the inductor wiring 20. The surface of the first via 41 that faces the first positive direction X1 side is connected to the first inner side pad portion 21PI. The second via 42 has a columnar shape. The material of the second via 42 is the same as the material of the inductor wiring 20. The surface of the second via 42 that faces the first positive direction X1 side is connected to the first outer side pad portion 21PO.

As illustrated in FIG. 5, the second insulating layer 62 covers the surface of the first inductor wiring 21 of the third layer L3 that faces the first negative direction X2 and the surface of the first side surface insulating layer 61A that faces the first negative direction X2, except for the parts where the first via 41 and the second via 42 are positioned. That is, the second insulating layer 62 is laminated on the surface of the first inductor wiring 21 opposite to the first magnetic layer 51. The second interlayer magnetic layer 52A configures a part of the fourth layer L4 excluding the two columnar wirings 40 and the second insulating layer 62. When viewed through toward the first positive direction X1 side, the outer edge of the first insulating layer 61 and the outer edge of the second insulating layer 62 match each other. However, the “match” here means that manufacturing errors and the like are allowed. Specifically, even when there is a shift of approximately 15 μm between the two outer edges, the two outer edges are assumed to match each other.

As illustrated in FIG. 5, a fifth layer L5 is laminated on the surface of the fourth layer L4 on the first negative direction X2 side. In the present embodiment, the dimension of the fifth layer L5 in the direction orthogonal to the main surface 11A is 70 μm. The fifth layer L5 includes the second inductor wiring 22, the connection wiring 23, the second side surface insulating layer 62A, and a second part P2 of the second magnetic layer 52.

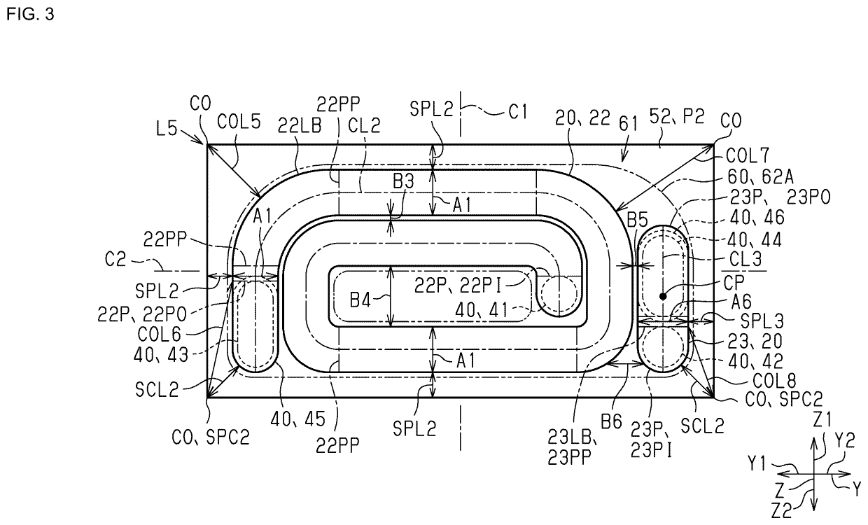

As illustrated in FIG. 3, the second inductor wiring 22 extends parallel to the main surface 11A and in a spiral shape. When viewed through toward the first positive direction X1 side, the second inductor wiring 22 is positioned within the range of the first insulating layer 61. As illustrated in FIG. 5, the second inductor wiring 22 includes a second seed layer 22A. The second seed layer 22A is disposed on the surface of the second insulating layer 62 on the first negative direction X2 side. The second seed layer 22A is in contact with the second insulating layer 62. The material of the second seed layer 22A is copper. By performing electrolytic copper plating on the second seed layer 22A, copper grows on the second seed layer 22A, and the entire second inductor wiring 22 is formed. As described above, the second inductor wiring 22 is disposed on the surface of the second insulating layer 62 opposite to the first inductor wiring 21.

As illustrated in FIG. 3, the second inductor wiring 22 includes a pair of second pad portions 22P and a second wiring main body 22LB. The definition of the boundary line between the second wiring main body 22LB and the second pad portion 22P is the same as that of the first inductor wiring 21. The pair of second pad portions 22P are positioned at both end portions of the second inductor wiring 22. One of the pair of second pad portions 22P is defined as a second inner side pad portion 22PI. The remaining one of the pair of second pad portions 22P is defined as a second outer side pad portion 22PO. The second inner side pad portion 22PI is positioned on the second negative direction Y2 side and the third negative direction Z2 side with respect to the geometric center of the fifth layer L5 when viewed through in the first positive direction X1. In addition, the surface of the second inner side pad portion 22PI that faces the first positive direction X1 side is connected to the first via 41. That is, the first via 41 connects the first inductor wiring 21 and the second inductor wiring 22 in series. The second outer side pad portion 22PO is positioned on the second positive direction Y1 side and on the third negative direction Z2 side with respect to the geometric center of the fifth layer L5 when viewed through in the first positive direction X1.

The second wiring main body 22LB is connected to the pair of second pad portions 22P. Specifically, when the fifth layer L5 is viewed in the first positive direction X1, the second wiring main body 22LB extends such that the diameter increases as the number of turns increases counterclockwise from the second inner side pad portion 22PI toward the second outer side pad portion 22PO. The number of turns of the second inductor wiring 22 is 1.5. That is, the number of turns of the first inductor wiring 21 is less than the number of turns of the second inductor wiring 22.

The number of turns of the second inductor wiring 22 is similarly determined based on the virtual vector. The starting point of the virtual vector is disposed on a center line CL2 of the second inductor wiring 22. Then, regarding the virtual vector, when the starting point is moved from the state of being disposed at the first end of the center line CL2 to the second end of the center line CL2 when viewed in the first positive direction X1, when the angle by which the orientation of the virtual vector is rotated is 360 degrees, the number of turns is determined as 1.0. However, when the orientation of the virtual vector is wound a plurality of times, or when the winding is continuous in the same direction, the number of turns increases. The center line CL2 of the second wiring main body 22LB matches the center line CL2 of the second inductor wiring 22. In the present embodiment, the center line CL2 of the second wiring main body 22 will also be given the same reference numeral as the center line CL2 of the second inductor wiring 22LB.

The connection wiring 23 is positioned on the second negative direction Y2 side of the second inductor wiring 22. The connection wiring 23 extends parallel to the main surface 11A. The connection wiring 23 is positioned within the range of the first insulating layer 61 when viewed through toward the first positive direction X1 side. In particular, the connection wiring 23 is positioned within the range of the first inductor wiring 21 when viewed through toward the first positive direction X1 side. Specifically, the connection wiring 23 extends in a straight line parallel to the third axis Z. Although not illustrated, the connection wiring 23 includes a seed layer similar to the first inductor wiring 21 and the second inductor wiring 22.

As illustrated in FIG. 3, the connection wiring 23 has a pair of third pad portions 23P and a connection wiring main body 23LB. The definition of the boundary line between the connection wiring main body 23LB and the third pad portion 23P is the same as that of the first inductor wiring 21. The pair of third pad portions 23P are positioned at both end portions of the connection wiring 23. One of the pair of third pad portions 23P is defined as a third corner side pad portion 23PI. The remaining one of the pair of third pad portions 23P is defined as a third central side pad portion 23PO. The third corner side pad portion 23PI is positioned on the second negative direction Y2 side and the third negative direction Z2 side with respect to the geometric center of the fifth layer L5 when viewed through in the first positive direction X1. In addition, the surface of the third corner side pad portion 23PI that faces the first positive direction X1 side is connected to the second via 42. That is, the second via 42 connects the first inductor wiring 21 and the connection wiring 23 in series. The third central side pad portion 23PO is positioned on the second negative direction Y2 side with respect to the geometric center of the fifth layer L5 when viewed through in the first positive direction X1.

The connection wiring main body 23LB connects the pair of third pad portions 23P to each other. Specifically, when the fifth layer L5 is viewed in the first positive direction X1, the connection wiring main body 23LB extends in a straight line from the third corner side pad portion 23PI toward the third central side pad portion 23PO.

As illustrated in FIG. 5, among the outer surfaces of the second inductor wiring 22, a surface excluding a surface that faces the first positive direction X1 and a surface that faces the first negative direction X2 is defined as a side surface of the second inductor wiring 22. In addition, among the outer surfaces of the connection wiring 23, a surface excluding the surface that faces the first positive direction X1 and the surface that faces the first negative direction X2 is defined as a side surface of the connection wiring 23. The second side surface insulating layer 62A covers the entire side surface of the second inductor wiring 22 and the entire side surface of the connection wiring 23. In addition, the second side surface insulating layer 62A is positioned within the range of the first insulating layer 61 when viewed through toward the first positive direction X1 side.

The second part P2 configures a part of the fifth layer L5 excluding the second inductor wiring 22, the connection wiring 23, and the second side surface insulating layer 62A. That is, the second part P2 is a part of the element body 11 in the same layer as the second inductor wiring 22 in the direction orthogonal to the main surface 11A. As described above, the second magnetic layer 52 including the first part P1 and the second part P2 is positioned in the same layer as the inductor wiring 20 in the direction orthogonal to the main surface 11A. When viewed through in the first positive direction X1, the shape of the first part P1 and the shape of the second part P2 match each other.

A sixth layer L6 is laminated on the surface of the fifth layer L5 on the first negative direction X2 side. In the present embodiment, the dimension of the sixth layer L6 in the direction orthogonal to the main surface 11A is 10 The sixth layer L6 has two columnar wirings 40, a third insulating layer 63, and a third interlayer magnetic layer 53A.

As illustrated in FIG. 2, the two columnar wirings 40 on the sixth layer L6 are a third via 43 and a fourth via 44. The third via 43 has a columnar shape having a substantially elliptical cross section. The material of the third via 43 is the same as the material of the inductor wiring 20. The surface of the third via 43 that faces the first positive direction X1 side is connected to the second outer side pad portion 22PO of the second inductor wiring 22. The fourth via 44 has a columnar shape having a substantially elliptical cross section. The material of the fourth via 44 is the same as the material of the inductor wiring 20. The surface of the fourth via 44 that faces the first positive direction X1 side is connected to the third central side pad portion 23PO of the connection wiring 23.

As illustrated in FIG. 5, the third insulating layer 63 is laminated on a part of the surface of the fifth layer L5 on the first negative direction X2 side. The formation region of the third insulating layer 63 corresponds to the position of the first insulating layer 61, except for the part where the third via 43 and the fourth via 44 are positioned, when viewed through in the direction orthogonal to the main surface 11A. The third interlayer magnetic layer 53A configures a part of the sixth layer L6 other than the third via 43, the fourth via 44, and the third insulating layer 63.

A seventh layer L7 is laminated on the surface of the sixth layer L6 on the first negative direction X2 side. In the present embodiment, the dimension of the seventh layer L7 in the direction orthogonal to the main surface 11A is 70 μm. The seventh layer L7 has two columnar wirings 40 and the third magnetic layer 53.

As illustrated in FIGS. 1 and 2, the two columnar wirings 40 of the seventh layer L7 are a first extension wiring 45 and a second extension wiring 46. The first extension wiring 45 has a columnar shape having a substantially elliptical cross section. The major axis and the minor axis of the first extension wiring 45 are slightly greater than the major axis and the minor axis of the third via 43. The material of the first extension wiring 45 is the same as the material of the inductor wiring 20. The surface of the first extension wiring 45 on the first negative direction X2 side is exposed from the mounting surface 11B. The surface of the first extension wiring 45 that faces the first negative direction X2 side is connected to the first outer electrode 31. In addition, the surface of the first extension wiring 45 that faces the first positive direction X1 side is connected to the third via 43. That is, the first extension wiring 45 connects the second inductor wiring 22 and the first outer electrode 31 with the third via 43 interposed therebetween.

The second extension wiring 46 has a columnar shape having a substantially elliptical cross section. The major axis and the minor axis of the second extension wiring 46 are slightly greater than the major axis and the minor axis of the fourth via 44. The surface of the second extension wiring 46 on the first negative direction X2 side is exposed from the mounting surface 11B. The surface of the second extension wiring 46 on the first negative direction X2 side is connected to the second outer electrode 32. In addition, the surface of the second extension wiring 46 that faces the first positive direction X1 side is connected to the fourth via 44. That is, the second extension wiring 46 connects the connection wiring 23 and the second outer electrode 32 to each other via the fourth via 44.

As illustrated in FIG. 5, the third magnetic layer 53 configures a part of the seventh layer L7 excluding the first extension wiring 45 and the second extension wiring 46. That is, the third magnetic layer 53 is positioned on the side opposite to the main surface 11A with respect to the second inductor wiring 22. The surface of the third magnetic layer 53 on the first negative direction X2 side is the mounting surface 11B. In addition, the third magnetic layer 53 is positioned around the two columnar wirings 40. The third magnetic layer 53 is in contact with the two columnar wirings 40.

Further, as described above, the dimension of the seventh layer L7 in the direction orthogonal to the main surface 11A is less than the dimension of the first layer L1 in the direction orthogonal to the main surface 11A. That is, the dimension of the third magnetic layer 53 in the direction orthogonal to the main surface 11A is less than the dimension of the first magnetic layer 51 in the direction orthogonal to the main surface 11A.

An eighth layer L8 is laminated on the surface of the seventh layer L7 on the first negative direction X2 side. The eighth layer L8 includes two outer electrodes 30 and a solder resist 70. In the present embodiment, the dimension of the solder resist 70 in the direction orthogonal to the main surface 11A is 10 μm. On the other hand, in the present embodiment, the dimension of each of the outer electrodes 30 in the direction orthogonal to the main surface 11A is 10.1 μm.

As illustrated in FIG. 2, the two outer electrodes 30 are the first outer electrode 31 and the second outer electrode 32. Each outer electrode 30 has a substantially rectangular shape when viewed in the first positive direction X1. The two outer electrodes 30 have the same shape. As described above, the first outer electrode 31 is connected to the first extension wiring 45. The second outer electrode 32 is connected to a second extension wiring 46. The part of the eighth layer L8 excluding the two outer electrodes 30 is the solder resist 70. The solder resist 70 has higher insulation than that of the element body 11.

As described above, the first insulating layer 61 covers the surface of the first inductor wiring 21 on the first positive direction X1 side. Further, the first side surface insulating layer 61A covers the side surfaces of the first inductor wiring 21. The second insulating layer 62 covers the surface of the first inductor wiring 21 on the first negative direction X2 side and the surface of the second inductor wiring 22 on the first positive direction X1 side. The second side surface insulating layer 62A covers the side surfaces of the second inductor wiring 22. Further, the third insulating layer 63 covers the second inductor wiring 22 on the first negative direction X2 side. As described above, all of the outer surfaces of the inductor wirings 20 are covered with the insulating layer 60 and the columnar wiring 40. That is, the inductor wiring 20 is not in contact with the magnetic layer 50 either. Specifically, the inductor wiring 20 is not in contact with the first magnetic layer 51, the second magnetic layer 52, the third magnetic layer 53, the first interlayer magnetic layer 51A, and the second interlayer magnetic layer 52A.

In addition, among the side surfaces 11C of the element body 11, the side surfaces 11C including a long side of the main surface 11A are defined as specific side surfaces SP11C. The specific side surface SP11C includes side surfaces of the first magnetic layer 51, the second magnetic layer 52, the third magnetic layer 53, the first interlayer magnetic layer 51A, the second interlayer magnetic layer 52A, and the third interlayer magnetic layer 53A. That is, all regions of the specific side surface SP11C are magnetic layers.

In FIG. 5, the boundary of each layer is virtually indicated by one-dot chain line. On the other hand, adjacent magnetic layers 50 may be integrated. That is, there may be no clear boundary between the adjacent magnetic layers 50. In this respect, the same applies to the insulating layer 60, and there may be no clear boundary between adjacent insulating layers 60.

### Regarding Cross-sectional Area of Inductor Wiring

As illustrated in FIG. 5, in the first wiring main body 21LB and the second wiring main body 22LB, the cross-sectional shape of each wiring main body is a rectangular shape when viewed in a cross-sectional view at the cross section orthogonal to the center line. In the first wiring main body 21LB and the second wiring main body 22LB, a dimension in the direction orthogonal to the center line and orthogonal to the main surface 11A is defined as a thickness dimension. The thickness dimension of the first wiring main body 21LB is constant. In addition, the thickness dimension of the second wiring main body 22LB is constant. Further, as illustrated in FIG. 5, the dimension of the third layer L3 in the direction orthogonal to the main surface 11A and the dimension of the fifth layer L5 orthogonal to the main surface 11A are the same. That is, the thickness dimension of the first wiring main body 21LB is the same as the thickness dimension of the second wiring main body 22LB.

In addition, in the first wiring main body 21LB and the second wiring main body 22LB, a dimension in the direction orthogonal to the center line and parallel to the main surface 11A is defined as a width dimension. As illustrated in FIG. 3, a width dimension A1 of the second wiring main body 22LB is constant. As described above, since the thickness dimension of the second wiring main body 22LB is also constant, the cross-sectional area of the cross section orthogonal to the center line CL2 of the second wiring main body 22LB is constant. The constant width dimension means that manufacturing errors are allowed. That is, the constant width dimension means that, with respect to the average value of the width dimension at a plurality of locations, the value at which the difference from the average value is the maximum is 20% or less of the average value. The same applies to the thickness dimension in this respect.

As illustrated in FIG. 4, in the first wiring main body 21LB, the width dimension at the position in the vicinity of the first outer side pad portion 21PO is greater than the width dimension at the position in the vicinity of the first inner side pad portion 21PI. Specifically, a width dimension A2 from 0 turn to 0.25 turn with the first inner side pad portion 21PI of the first inductor wiring 21 as the starting point is the minimum width dimension in the first wiring main body 21LB. The width dimension A2 of the first wiring main body 21LB is the same as the width dimension A1 of the second wiring main body 22LB.

Further, the width dimension of the first wiring main body 21LB gradually increases from 0.25 turn to 0.75 turn of the first inductor wiring 21. In addition, a width dimension A3 from 0.75 turn to 1.0 turn of the first inductor wiring 21 is the maximum width dimension in the first wiring main body 21LB. The difference between the maximum value of the width dimension of the first wiring main body 21LB and the minimum value of the width dimension of the first wiring main body 21LB is 2 or more times. In other words, the maximum value of the width dimension of the first wiring main body 21LB is two or more times the maximum value of the width dimension of the second wiring main body 22LB. Further, according to such a relationship of the width dimension, the maximum cross-sectional area in the cross section orthogonal to the center line CL1 of the first wiring main body 21LB is two or more times the maximum cross-sectional area in the cross section orthogonal to the center line CL2 of the second wiring main body 22LB.

The first wiring main body 21LB has a maximum point where the cross-sectional area is the maximum in the cross section orthogonal to the center line CL1 of the first wiring main body 21LB and the cross section orthogonal to the center line CL2 of the second wiring main body 22LB. The maximum point matches the location where the width dimension is the maximum in the first wiring main body 21LB. In addition, the first wiring main body 21LB has a minimum point where the cross-sectional area is the minimum in the cross section orthogonal to the center line CL1 of the first wiring main body 21LB and the cross section orthogonal to the center line CL2 of the second wiring main body 22LB. The minimum point matches the location where the width dimension is the minimum in the first wiring main body 21LB. Further, the cross-sectional area of the minimum point in the first wiring main body 21LB matches the cross-sectional area of the second wiring main body 22LB. Therefore, the second wiring main body 22LB also has a minimum point. The cross-sectional area at the maximum point is two or more times greater than the cross-sectional area at the minimum point.

As illustrated in FIG. 5, it is assumed that a cross-sectional view is taken at the cross section orthogonal to the center line CL1 at the maximum point of the first wiring main body 21LB. At this time, two minimum points of the second wiring main bodies 22LB are positioned on the first negative direction X2 side of the maximum points of the first wiring main bodies 21LB. That is, the second wiring main bodies 22LB are positioned at two locations within the range of the surface that faces the main surface 11A among the outer surfaces of the first wiring main body 21LB in the direction parallel to the main surface 11A.

### Regarding Positional Relationship Between Columnar Wiring and Center Line of Inductor Wiring

As illustrated in FIG. 3, the first via 41 overlaps the center line CL2 of the second inductor wiring 22 when viewed through in the direction orthogonal to the main surface 11A. Further, as illustrated in FIG. 4, the first via 41 overlaps the center line CL1 of the first inductor wiring 21 when viewed through in the direction orthogonal to the main surface 11A. Specifically, the geometric center of the first via 41 is positioned on the center line CL2 of the second inductor wiring 22 and on the center line CL1 of the first inductor wiring 21.

As illustrated in FIG. 3, the second via 42 overlaps the center line CL3 of the connection wiring 23 when viewed through in the direction orthogonal to the main surface 11A. Specifically, the geometric center of the second via 42 is positioned on the center line CL3 of the connection wiring 23. On the other hand, as illustrated in FIG. 4, when viewed through in the direction orthogonal to the main surface 11A, the second via 42 is connected to the first inductor wiring 21 at a location that does not overlap the center line CL1 of the first inductor wiring 21. Specifically, the entire region of the second via 42 is positioned on the second negative direction Y2 side with respect to the center line CL1 of the first inductor wiring 21.

Further, as illustrated in FIG. 3, the third via 43 overlaps the center line CL2 of the second inductor wiring 22 when viewed through in the direction orthogonal to the main surface 11A. Specifically, the geometric center of the third via 43 is positioned on the center line CL2 of the second inductor wiring 22. The fourth via 44 overlaps the center line CL3 of the connection wiring 23 when viewed through in the direction orthogonal to the main surface 11A. Specifically, the geometric center of the fourth via 44 is positioned on the center line CL3 of the connection wiring 23. In addition, the first extension wiring 45 overlaps the center line CL2 of the second inductor wiring 22 when viewed through in the direction orthogonal to the main surface 11A. Specifically, the geometric center of the first extension wiring 45 is positioned on the center line CL2 of the second inductor wiring 22. The second extension wiring 46 overlaps the center line CL3 of the connection wiring 23 when viewed through in the direction orthogonal to the main surface 11A. Specifically, the geometric center of the second extension wiring 46 is positioned on the center line CL3 of the connection wiring 23.

Here, when viewed through in the direction orthogonal to the main surface 11A, an axis that passes through the geometric center of the main surface 11A and is parallel to the short side of the main surface 11A is defined as a first central axis C1. In addition, an axis that passes through the geometric center of the main surface 11A, is orthogonal to the first central axis C1, and is parallel to the main surface 11A is defined as a second central axis C2. Then, when viewed through in the direction orthogonal to the main surface 11A, the second via 42 overlaps neither the first central axis C1 nor the second central axis C2. Specifically, the second via 42 is positioned near a corner portion CO on the second negative direction Y2 side and the third negative direction Z2 side with respect to the geometric center of the main surface 11A.

Here, as illustrated in FIG. 3, the midpoint in the extending direction of the center line CL3 of the connection wiring 23 is defined as a connection midpoint CP. The second via 42 does not overlap the connection midpoint CP when viewed through in the direction orthogonal to the main surface 11A.

### Regarding Distance Between Inductor Wiring and Corner Portion

As illustrated in FIG. 4, it is assumed that the element body 11 is viewed through in the first positive direction X1. In the pair of first pad portions 21P, a pad portion adjacent to the outer edge of the main surface 11A without other part of the inductor wiring 20 therebetween is defined as a first specific pad portion. In the present embodiment, the first specific pad portion is the first outer side pad portion 21PO. Hereinafter, the first outer side pad portion 21PO may be described as the first specific pad portion 21PO.

It is assumed that the element body 11 is viewed through in the first positive direction X1. In this case, among the four corner portions CO of the main surface 11A, the corner portion CO closest to the first specific pad portion 21PO is defined as a first specific corner portion SPC1. In the present embodiment, since the element body 11 has a substantially rectangular parallelepiped shape, the four corner portions CO are four vertices of the main surface 11A having a substantially rectangular parallelepiped shape. Therefore, the first specific corner portion SPC1 is the corner portion CO positioned on the second negative direction Y2 side and the third negative direction Z2 side with respect to the geometric center of the third layer L3.

A shortest distance SCL1 from the first specific corner portion SPC1 to the outer edge of the first specific pad portion 21PO is less than the shortest distance from any corner portion CO excluding the first specific corner portion SPC1 to the first wiring main body 21LB. Specifically, the shortest distance SCL1 is less than a shortest distance COL1 from the corner portion CO positioned on the second positive direction Y1 side and the third positive direction Z1 side to the first wiring main body 21LB with respect to the geometric center of the third layer L3. In addition, the shortest distance SCL1 is less than a shortest distance COL2 from the corner portion CO positioned on the second positive direction Y1 side and the third negative direction Z2 side to the first wiring main body 21LB with respect to the geometric center of the third layer L3. Furthermore, the shortest distance SCL1 is less than a shortest distance COL3 from the corner portion CO positioned on the second negative direction Y2 side and the third positive direction Z1 side to the first wiring main body 21LB with respect to the geometric center of the third layer L3.

As illustrated in FIG. 3, it is assumed that the element body 11 is viewed through in the first positive direction X1. In the pair of second pad portions 22P and the pair of third pad portions 23P, a pad portion adjacent to the outer edge of the main surface 11A without other part of the inductor wiring 20 therebetween is defined as a second specific pad portion. In the present embodiment, the second specific pad portion is the second outer side pad portion 22PO or the third corner side pad portion 23PI. Hereinafter, the second outer side pad portion 22PO or the third corner side pad portion 23PI may be described as the second specific pad portion 22PO or the second specific pad portion 23PI.

It is assumed that the element body 11 is viewed through in the first positive direction X1. In this case, among the four corner portions CO of the main surface 11A, the corner portion CO closest to the second specific pad portion is defined as a second specific corner portion SPC2. In the present embodiment, since the element body 11 has a substantially rectangular parallelepiped shape, the four corner portions CO are four vertices of the main surface 11A having a substantially rectangular parallelepiped shape. Therefore, when the second outer side pad portion 22PO is the second specific pad portion 22PO, the second specific corner portion SPC2 is the corner portion CO positioned on the second positive direction Y1 side and on the third negative direction Z2 side with respect to the geometric center of the fifth layer L5. Otherwise, when the third corner side pad portion 23PI is the second specific pad portion 23PI, the second specific corner portion SPC2 is the corner portion CO positioned on the second negative direction Y2 side and on the third negative direction Z2 side with respect to the geometric center of the fifth layer L5.

A shortest distance SCL2 from the second specific corner portion SPC2 to the outer edge of the second specific pad portion is less than the shortest distance from any corner portion CO excluding the second specific corner portion SPC2 to the second wiring main body 22LB. In the present embodiment, a shortest distance COL6 from the corner portion CO closest to the second outer side pad portion 22PO to the second outer side pad portion 22PO, and a shortest distance COL8 from the corner portion CO closest to the third corner side pad portion 23PI to the third corner side pad portion 23PI are the same.

Specifically, the shortest distance SCL2 is less than a shortest distance COLS from the corner portion CO positioned on the second positive direction Y1 side and the third positive direction Z1 side to the second wiring main body 22LB with respect to the geometric center of the fifth layer L5. In addition, the shortest distance SCL2 is less than a shortest distance COLT from the corner portion CO positioned on the second negative direction Y2 side and the third positive direction Z1 side to the second wiring main body 22LB with respect to the geometric center of the fifth layer L5. Furthermore, when the second outer side pad portion 22PO is defined as the second specific pad portion 22PO, the shortest distance SCL2 is less than the shortest distance COL8 from the corner portion CO positioned on the second negative direction Y2 side and the third negative direction Z2 side to the connection wiring main body 23LB with respect to the geometric center of the fifth layer L5. In addition, when the third corner side pad portion 23PI is defined as the second specific pad portion 23PI, the shortest distance SCL2 is less than the shortest distance COL6 from the corner portion CO positioned on the second positive direction Y1 side and the third negative direction Z2 side to the second wiring main body 22LB with respect to the geometric center of the fifth layer L5.

Further, as illustrated in FIGS. 3 and 4, the shortest distance SCL1 from the first specific corner portion SPC1 to the outer edge of the first specific pad portion 21PO is less than the shortest distance from any corner portion CO excluding the first specific corner portion SPC1 to the first wiring main body 21LB, the second wiring main body 22LB, and the connection wiring main body 23LB.

Specifically, as described above, the shortest distance SCL1 is less than the shortest distance COL1 from the corner portion CO positioned on the second positive direction Y1 side and the third positive direction Z1 side to the first wiring main body 21LB with respect to the geometric center of the third layer L3. In addition, the shortest distance SCL1 is less than the shortest distance COLS from the corner portion CO positioned on the second positive direction Y1 side and the third positive direction Z1 side to the second wiring main body 22LB with respect to the geometric center of the fifth layer L5. Further, as described above, the shortest distance SCL1 is less than the shortest distance COL2 from the corner portion CO positioned on the second positive direction Y1 side and the third negative direction Z2 side to the first wiring main body 21LB with respect to the geometric center of the third layer L3. In addition, the shortest distance SCL1 is less than the shortest distance COLE from the corner portion CO positioned on the second positive direction Y1 side and the third negative direction Z2 side to the second wiring main body 22LB with respect to the geometric center of the fifth layer L5. The shortest distance SCL1 is less than a shortest distance COL3 from the corner portion CO positioned on the second negative direction Y2 side and the third positive direction Z1 side to the first wiring main body 21LB with respect to the geometric center of the third layer L3. In addition, the shortest distance SCL1 is less than the shortest distance COLT from the corner portion CO positioned on the second negative direction Y2 side and the third positive direction Z1 side to the second wiring main body 22LB with respect to the geometric center of the fifth layer L5.

Further, as illustrated in FIGS. 3 and 4, the shortest distance SCL2 from the second specific corner portion SPC2 to the outer edge of the second specific pad portion is less than the shortest distance from any corner portion CO excluding the second specific corner portion SPC2 to the first wiring main body 21LB, the second wiring main body 22LB, and the connection wiring main body 23LB.

Specifically, the shortest distance SCL2 is less than the shortest distance COL1 from the corner portion CO positioned on the second positive direction Y1 side and the third positive direction Z1 side to the first wiring main body 21LB with respect to the geometric center of the third layer L3. Further, as described above, the shortest distance SCL2 is less than the shortest distance COL5 from the corner portion CO positioned on the second positive direction Y1 side and the third positive direction Z1 side to the second wiring main body 22LB with respect to the geometric center of the fifth layer L5. In addition, the shortest distance SCL2 is less than the shortest distance COL3 from the corner portion CO positioned on the second negative direction Y2 side and the third positive direction Z1 side to the first wiring main body 21LB with respect to the geometric center of the third layer L3. Further, as described above, the shortest distance SCL2 is less than the shortest distance COL7 from the corner portion CO positioned on the second negative direction Y2 side and the third positive direction Z1 side to the second wiring main body 22LB with respect to the geometric center of the fifth layer L5. Furthermore, when the second outer side pad portion 22PO is defined as the second specific pad portion 22PO, the shortest distance SCL2 is less than the shortest distance COL4 from the corner portion CO positioned on the second negative direction Y2 side and the third negative direction Z2 side to the first wiring main body 21LB with respect to the geometric center of the third layer L3. In addition, the shortest distance SCL2 is less than the shortest distance COL8 from the corner portion CO positioned on the second negative direction Y2 side and the third negative direction Z2 side to the connection wiring main body 23LB with respect to the geometric center of the fifth layer L5. In addition, when the third corner side pad portion 23PI is defined as the second specific pad portion 23PI, the shortest distance SCL2 is less than the shortest distance COL2 from the corner portion CO positioned on the second positive direction Y1 side and the third negative direction Z2 side to the first wiring main body 21LB with respect to the geometric center of the third layer L3. In addition, the shortest distance SCL2 is less than the shortest distance COLE from the corner portion CO positioned on the second positive direction Y1 side and the third negative direction Z2 side to the second wiring main body 22LB with respect to the geometric center of the fifth layer L5.

### Regarding Parallel Part of Wiring Main Body

As illustrated in FIG. 4, the first wiring main body 21LB has four first parallel parts 21PP. The first parallel part 21PP is a part of the first wiring main body 21LB in which the center line CL1 extends parallel to a side of the main surface 11A, and which is adjacent to the side without interposing other parts of the inductor wiring 20 therebetween. Specifically, the first parallel parts 21PP are present at four locations on the second positive direction Y1 side, the second negative direction Y2 side, the third positive direction Z1 side, and the third negative direction Z2 side with respect to the geometric center of the third layer L3. That is, two of the first parallel parts 21PP extend parallel to the long side of the main surface 11A. The other two of the first parallel parts 21PP extend parallel to the short side of the main surface 11A. The “parallel” here means that manufacturing errors and the like are allowed. Specifically, when the element body 11 is viewed through in the direction orthogonal to the main surface 11A, when the angle formed by the center line CL1 and the side of the main surface 11A is less than 5 degrees, the sides are regarded as parallel.

Here, when the element body 11 is viewed through in the direction orthogonal to the main surface 11A, the shortest distance from the side corresponding to each of the first parallel parts 21PP to the first parallel part 21PP is defined as a first specific distance SPL1. The first specific distances SPL1 of the first parallel parts 21PP at the four locations are substantially equal to each other. The first specific distance SPL1 is less than the first width dimension which is the width dimension of the corresponding first parallel part 21PP. Specifically, the first specific distance SPL1 corresponding to the short side of the main surface 11A on the second positive direction Y1 side is approximately one fourth of a first width dimension A4 of the first parallel part 21PP corresponding to the side. In addition, the first specific distance SPL1 corresponding to the short side of the main surface 11A on the second negative direction Y2 side is approximately one fourth of a first width dimension A5 of the first parallel part 21PP corresponding to the side. Furthermore, the first specific distance SPL1 corresponding to the long side of the main surface 11A on the third positive direction Z1 side is approximately one fourth of the first width dimension A3 of the first parallel part 21PP corresponding to the side. Furthermore, the first specific distance SPL1 corresponding to the long side of the main surface 11A on the third negative direction Z2 side is approximately a half of the first width dimension A2 of the first parallel part 21PP corresponding to the side.

The shortest distance from any point on the outer edge of the first inductor wiring 21 to another point on the outer edge of the inductor wiring 20 without interposing the inductor wiring 20 therebetween is defined as a first inter-wiring distance of the first inductor wiring 21 at any point. The case where the line segment connecting the two points matches the outer edge of the inductor wiring 20 corresponds to the above description “interposing the inductor wiring 20 therebetween”. At this time, there is a location where the first inter-wiring distance is less than the first specific distance SPL1. Specifically, in the first inductor wiring 21, a first inter-wiring distance B1 between the location where the number of turns is 0 obtained by counting from the first inner side pad portion 21PI and the location where the number of turns is 1.0 obtained by counting from the first inner side pad portion 21PI is less than the first specific distance SPL1. The first side surface insulating layer 61A is present in the range of the first inter-wiring distance B1. On the other hand, there is also a location where the first inter-wiring distance is greater than the first specific distance SPL1. Specifically, in the first inductor wiring 21, a first inter-wiring distance B2 between the location where the number of turns is 0.25 obtained by counting from the first inner side pad portion 21PI and the location where the number of turns is 0.75 obtained by counting from the first inner side pad portion 21PI is longer than the first specific distance SPL1. The first part P1 of the second magnetic layer 52 and the first side surface insulating layer 61A are present within the range of the first inter-wiring distance B2.

As illustrated in FIG. 3, the second wiring main body 22LB has three second parallel parts 22PP. The second parallel part 22PP is a part of the second wiring main body 22LB in which the center line CL2 extends parallel to a side of the main surface 11A, and which is adjacent to the side without interposing other parts of the inductor wiring 20 therebetween. Specifically, the second parallel parts 22PP are present at three locations on the second positive direction Y1 side, the third positive direction Z1 side, and the third negative direction Z2 side with respect to the geometric center of the fifth layer L5. That is, two of the second parallel parts 22PP extend parallel to the long side of the main surface 11A. The other one of the second parallel parts 22PP extend parallel to the short side of the main surface 11A. In addition, the second parallel part 22PP is present on the first negative direction X2 side with respect to the first parallel part 21PP.

Here, when the element body 11 is viewed through in the direction orthogonal to the main surface 11A, the shortest distance from the side corresponding to each of the second parallel parts 22PP to the second parallel part 22PP is defined as a second specific distance SPL2. The second specific distances SPL2 of the second parallel parts 22PP at the three locations are substantially equal to each other. The second specific distance SPL2 is less than the second width dimension which is the width dimension of the corresponding second parallel part 22PP. Specifically, the second specific distance SPL2 corresponding to the short side of the main surface 11A on the second positive direction Y1 side is approximately a half of the second width dimension A1 of the second parallel part 22PP corresponding to the side. The second specific distance SPL2 corresponding to the long side of the main surface 11A on the third positive direction Z1 side is approximately a half of the second width dimension A1 of the second parallel part 22PP corresponding to the side. The second specific distance SPL2 corresponding to the long side of the main surface 11A on the third negative direction Z2 side is approximately a half of the second width dimension A1 of the second parallel part 22PP corresponding to the side.

The first specific distance SPL1 corresponding to the first parallel part 21PP and the second specific distance SPL2 corresponding to the second parallel part 22PP positioned on the first negative direction X2 side of the first parallel part 21PP are the same. On the other hand, in the four first parallel parts 21PP, the first width dimension of the first parallel part 21PP corresponding to the long side of the main surface 11A on the third positive direction Z1 side is greater than the second width dimension of the second parallel part 22PP. In addition, in the four first parallel parts 21PP, the first width dimension of the first parallel part 21PP corresponding to both short sides of the main surface 11A is greater than the second width dimension of the second parallel part 22PP. Therefore, the ratio between the first width dimension of the three first parallel parts 21PP and the first specific distance SPL1 corresponding to the first parallel part 21PP is different from the ratio between the second width dimension of the second parallel part 22PP and the second specific distance SPL2 corresponding to the second parallel part 22PP.

The shortest distance from any point on the outer edge of the second inductor wiring 22 to another point on the outer edge of the inductor wiring 20 without interposing the inductor wiring 20 therebetween is defined as a second inter-wiring distance of the second inductor wiring 22 at any point. At this time, there is a location where the second inter-wiring distance is less than the second specific distance SPL2. Specifically, in the second inductor wiring 22, a second inter-wiring distance B3 between the location where the number of turns is 0.25 obtained by counting from the second inner side pad portion 22PI and the location where the number of turns is 1.25 obtained by counting from the second inner side pad portion 22PI is less than the second specific distance SPL2. The second side surface insulating layer 62A is present in the range of the second inter-wiring distance B3. On the other hand, there is also a location where the second inter-wiring distance is greater than the second specific distance SPL2. Specifically, in the second inductor wiring 22, a second inter-wiring distance B4 between the location where the number of turns is 0.25 obtained by counting from the second inner side pad portion 22PI and the location where the number of turns is 0.75 obtained by counting from the second inner side pad portion 22PI is longer than the second specific distance SPL2. The second part P2 of the second magnetic layer 52 and the second side surface insulating layer 62A are present within the range of the second inter-wiring distance B4.

As illustrated in FIG. 3, the connection wiring main body 23LB has a third parallel parts 23PP. The third parallel part 23PP is a part of the connection wiring main body 23LB in which the center line CL3 extends parallel to a side of the main surface 11A, and which is adjacent to the side without interposing other parts of the inductor wiring 20 therebetween. Specifically, the third parallel part 23PP is present on the second negative direction Y2 side with respect to the geometric center of the fifth layer L5. That is, the third parallel parts 23PP extend parallel to the short side of the main surface 11A. In addition, the third parallel part 23PP is present on the first negative direction X2 side with respect to the first parallel part 21PP.

Here, when the element body 11 is viewed through in the direction orthogonal to the main surface 11A, the shortest distance from the side corresponding to the third parallel part 23PP to the third parallel part 23PP is defined as a third specific distance SPL3. The third specific distance SPL3 is less than a third width dimension A6 which is the width dimension of the corresponding third parallel part 23PP. Specifically, the third specific distance SPL3 is approximately a half of the third width dimension A6 of the third parallel part 23PP.

Further, the shortest distance from any point on the outer edge of the connection wiring 23 to another point on the outer edge of the inductor wiring 20 without interposing the inductor wiring 20 therebetween is defined as a third inter-wiring distance of the connection wiring 23 at any point. At this time, there is a location where the third inter-wiring distance is less than the third specific distance SPL3. Specifically, a third inter-wiring distance B5 between the location where the number of turns is 1.0 obtained by counting from the second inner side pad portion 22PI of the second inductor wiring 22 and the third central side pad portion 23PO of the connection wiring 23 is less than the third specific distance SPL3. The second side surface insulating layer 62A is present in the range of the third inter-wiring distance. Further, there is a location where the third inter-wiring distance is greater than the third specific distance SPL3. Specifically, a third inter-wiring distance B6 in the vicinity of the end point of the third corner side pad portion 23PI on the third negative direction Z2 side is greater than the third specific distance SPL3.

### Regarding Effect of Present Embodiment

(1) According to the above embodiment, the shortest distance from the first specific corner portion SPC1 to the outer edge of the first specific pad portion 21PO is less than the shortest distance from any corner portion CO excluding the first specific corner portion SPC1 to the first wiring main body 21LB. Since the first specific pad portion 21PO is disposed closer to the first specific corner portion SPC1, the shape of the first wiring main body 21LB can be designed without limiting the position of the first pad portion 21P. That is, since the degree of freedom in the design of the first wiring main body 21LB can be improved, the wiring length of the inductor wiring 20 can be designed to be long. Further, since a sufficient distance is ensured as the distance from any corner portion CO excluding the first specific corner portion SPC1 to the first wiring main body 21LB, a magnetic path in the vicinity of the corner portion CO can be sufficiently ensured. From the above, it is easy to acquire a large value as the inductance value of the inductor component 10. The same applies to the second specific corner portion SPC2, the second specific pad portion 22PO, the second specific pad portion 23PI, and the second wiring main body 22LB.

(2) According to the above embodiment, the inductor wiring 20 includes the first inductor wiring 21 and the second inductor wiring 22. As described above, since the wiring length can be extended by having the inductor wiring 20 have a multilayer structure, a high inductance can be obtained as the inductor component 10.

(3) According to the above embodiment, the first part P1 and the second part P2 of the second magnetic layer 52 have the same shape, and there is no step between the two. Therefore, when forming the element body 11, a gap which is not filled with the element body 11 is less likely to be formed at the boundary part between the first inductor wiring 21 and the second inductor wiring 22.

(4) According to the above embodiment, the outer edge of the first insulating layer 61 and the outer edge of the second insulating layer 62 have the same shape. Therefore, when forming the element body 11, a gap which is not filled with the element body 11 is less likely to be formed at the boundary part between the first inductor wiring 21 and the second inductor wiring 22.

(5) According to the above embodiment, since the particle size of the metal magnetic powder is sufficiently small, even when the metal magnetic powder falls off from the element body 11, the inductor wiring 20 is less likely to be exposed to the outer surface of the element body 11.

(6) According to the above embodiment, the dimension of the third magnetic layer 53 in the direction orthogonal to the main surface 11A is less than the dimension of the first magnetic layer 51 in the direction orthogonal to the main surface 11A. According to this configuration, compared to the case where the dimension in the direction orthogonal to the main surface 11A of the third magnetic layer 53 is the same as the dimension in the direction orthogonal to the main surface 11A of the first magnetic layer 51, the dimensions of the first extension wiring 45 and the second extension wiring 46 in the direction orthogonal to the main surface 11A can be reduced. As the dimensions in the lamination direction of the first extension wiring 45 and the second extension wiring 46 increase, the shapes of these extension wiring wirings tend to collapse. Therefore, according to the above configuration, the degree of manufacturing difficulty of the first extension wiring 45 and the second extension wiring 46 can be reduced.

(7) In the above embodiment, the inductor wiring 20 is not in contact with the first magnetic layer 51, the second magnetic layer 52, and the third magnetic layer 53. In other words, the inductor wiring 20 is covered with the insulating layer 60. As a result, the insulation between the element body 11 and the inductor wiring 20 can be improved. Further, even when deformation, temperature change, or the like occurs in the element body 11, the inductor wiring 20 can be protected.

(8) According to the above embodiment, the first wiring main body 21LB includes the maximum point where the cross-sectional area of the cross section orthogonal to the center line CL1 of the first wiring main body 21LB is the maximum and the minimum point where the cross-sectional area of the cross section orthogonal to the center line CL is the minimum. In addition, the cross-sectional area at the maximum point is two or more times greater than the cross-sectional area at the minimum point. Accordingly, the DC electric resistance of the inductor component 10 can be reduced while suppressing the decrease in the inductance value of the inductor component 10. That is, according to the above configuration, the Q value of the inductor component 10 can be improved.

(9) According to the above embodiment, when viewed through in the direction orthogonal to the main surface 11A, the second via 42 is connected to the first inductor wiring 21 at a location that does not overlap the center line CL1 of the first inductor wiring 21. That is, the position of the columnar wiring 40 is not limited to the center line of the inductor wiring 20. Accordingly, the degree of freedom in design of the inductor wiring 20 is improved. At this time, according to the above configuration, the possibility that the inductor wiring 20 can be designed to improve the Q value increases.

(10) According to the above embodiment, the first specific distance SPL1 is less than the width dimension of the first parallel part 21PP. The magnetic flux around the first parallel part 21PP of the first inductor wiring 21 extends substantially in the direction orthogonal to the main surface 11A. Therefore, even when the dimension between the first parallel part 21PP and one side of the main surface 11A is small, the magnetic flux is less likely to saturate. On the other hand, by reducing the dimension between the first parallel part 21PP and one side of the main surface 11A, the other part of the element body 11 can be used as the part for routing the inductor wiring 20. Therefore, it is easy to design the inductor wiring 20 to be long. The same applies to the second specific distance SPL2 and the second parallel part 22PP in this respect.

### MODIFICATION EXAMPLE

The above embodiment and the following modification example can be implemented in combination with each other within a technically consistent range.

### Regarding Overall Configuration

In the above embodiment, the inductor component 10 does not include the outer electrode 30. In this case, when the inductor component 10 is mounted on the substrate, the part of the columnar wiring 40 exposed from the mounting surface 11B may be used.

In the particle size distribution of the magnetic powder, the median particle size (D50) may be greater than one tenth with respect to the shortest distance from the inductor wiring 20 to the outer edge of the main surface 11A when the element body 11 is viewed through in the direction orthogonal to the main surface 11A. Even when the median particle size of the magnetic powder is greater than one tenth, for example, when the outer surface of the inductor component 10 is resin-coated, it is easy to prevent the magnetic powder from shedding.

In the above embodiment, the dimension of each layer constituting the inductor component 10 in the direction along the first axis X is not limited to the example in the above embodiment. For example, the dimension of the first layer L1 in the direction along the first axis X may be less than the dimension of the seventh layer L7 in the direction along the first axis X. That is, the dimension of the first magnetic layer 51 in the direction along the first axis X may be less than the dimension of the third magnetic layer 53 in the direction along the first axis X.

In the above embodiment, the eighth layer L8 may be positioned on the first positive direction X1 side with respect to the first layer L1. In this case, the columnar wiring 40 for connecting each inductor wiring 20 to the outer electrode 30 may be provided on the first positive direction X1 side with respect to the first inductor wiring 21.

In the above embodiment, the manufacturing method of the inductor component 10 is not limited to SAP, and may be another manufacturing method. In this case, the first inductor wiring 21 does not include the first seed layer 21A. In this respect, the same applies to the second inductor wiring 22 and the connection wiring 23.

In the above embodiment, each of the columnar wirings 40 is not limited to the direction orthogonal to the main surface 11A as long as the columnar wirings 40 extend in the direction intersecting with the main surface 11A.

In the above embodiment, all the shapes of the columnar wirings 40 may be the same when viewed through in the direction orthogonal to the main surface 11A. In addition, the shape of each of the columnar wirings 40 when viewed through in the direction orthogonal to the main surface 11A may be different for each columnar wiring 40. That is, the columnar wiring 40 positioned in the same layer may have different shapes.

In the above embodiment, the second via 42 may overlap the connection midpoint CP of the connection wiring 23 when viewed through in the direction orthogonal to the main surface 11A. Further, none of the second via 42, the fourth via 44, and the second extension wiring 46 may overlap the connection midpoint CP.

In the above embodiment, when viewed through in the direction orthogonal to the main surface 11A, the second via 42 may overlap one or both of the first central axis C1 and the second central axis C2. That is, when viewed through in the direction orthogonal to the main surface 11A, the columnar wiring 40 that is connected to the inductor wiring 20 at the location that does not overlap the center line of the inductor wiring 20 may overlap the first central axis C1 and the second central axis C2.

In the above embodiment, when viewed through in the direction orthogonal to the main surface 11A, all the columnar wirings 40 may be connected to the inductor wiring 20 at the location that does not overlap the center line of the inductor wiring 20.

The inductor component 10 does not have one or more of the first side surface insulating layer 61A and the second side surface insulating layer 62A. Specifically, the surface of the first inductor wiring 21 on the first positive direction X1 side may be in direct contact with the first magnetic layer 51. The surface of the second inductor wiring 22 on the first negative direction X2 side may be in direct contact with the third magnetic layer 53.

According to the modification example, since an insulating film or the like is not provided on the side surfaces of the element body 11, the cross-sectional area of the parallel part of each wiring main body can be enlarged. As a result, DC resistance can be reduced and inductance can be improved.

In the specific side surface SP11C of the element body 11, not all regions need to be magnetic layers. The wiring, the insulating layer 60, and the like may be exposed on the specific side surface SP11C of the element body 11. For example, as illustrated in FIG. 6, a second end 81B of a support wiring 80 may be exposed.

When the element body 11 is viewed through in the direction orthogonal to the main surface 11A, the outer edge of the first insulating layer 61 and the outer edge of the second insulating layer 62 does not match each other. Further, when the outer edge of the first insulating layer 61 and the outer edge of the second insulating layer 62 match each other even at a part, for the part, the effect can be obtained that a gap which is not filled with the element body 11 is less likely to be formed at the boundary part between the first inductor wiring 21 and the second inductor wiring 22.

When the element body 11 is viewed through in the direction orthogonal to the main surface 11A, the shape of the first part P1 and the shape of the second part P2 does not match each other. Further, when the shape of the first part P1 and the shape of the second part P2 match each other even at a part, for the part, the effect can be obtained that a gap which is not filled with the element body 11 is less likely to be formed at the boundary part between the first inductor wiring 21 and the second inductor wiring 22.

When the inductor component 10 has six outer surfaces, the inductor component 10 is regarded as a rectangular parallelepiped even when the boundary between each plane is a curved surface. In addition, when the element body 11 is viewed from the direction orthogonal to the main surface 11A, and when the corner of the element body 11 does not have one vertex, the corner portion CO is defined as follows. First, when the element body 11 is viewed in the direction orthogonal to the main surface 11A, two substantially straight sides interposing a corner of the element body 11 therebetween are specified. Then, an intersection point when a virtual line extending the two sides is drawn is specified. A virtual line segment indicating the shortest distance to the wiring main body or the specific pad portion of the inductor wiring 20 is drawn from the intersection point. At this time, the intersection point between the virtual line segment and the outer edge of the element body 11 is defined as the corner portion CO.

### Regarding Inductor Wiring

In the above embodiment, the inductor wiring 20 may be only the first inductor wiring 21. That is, the inductor component 10 may be configured with one layer of the inductor wiring 20. Further, in addition to the first inductor wiring 21, the second inductor wiring 22, and the connection wiring 23, the inductor wiring 20 may further be included. For example, the inductor component 10 illustrated in FIG. 8 may be configured with one layer of the inductor wiring 20. As illustrated in FIG. 8, the surface of the inductor wiring 20 may be in direct contact with the magnetic layer 50.

The number of turns of the first inductor wiring 21 may be less than or the same as the number of turns of the second inductor wiring 22.

In the above embodiment, a part of the width dimension of the second inductor wiring 22 is not constant.

In the above embodiment, the inductor wiring 20 having the maximum point may be only the second inductor wiring 22.

According to the above embodiment, the cross-sectional area at the maximum point may be less than two times the cross-sectional area at the minimum point.

In the above embodiment, the relationship between the width dimension of the first wiring main body 21LB and the width dimension of the second wiring main body 22LB is not limited to the example of the above embodiment. That is, the second wiring main bodies 22LB is not positioned at two locations within the range of the surface that faces the main surface 11A among the outer surfaces of the first wiring main body 21LB in the direction parallel to the main surface 11A.

In the above embodiment, the width dimension of the first wiring main body 21LB may be constant. Further, the width dimension of the first wiring main body 21LB may be the same as the width dimension of the second wiring main body 22LB.

In the above embodiment, a part of the inductor wiring 20 is not covered with the insulating layer 60 and may be in contact with the magnetic layer 50.

In the above embodiment, the thickness dimension of the first wiring main body 21LB and the thickness dimension of the second wiring main body 22LB may be different.

In the above embodiment, the cross-sectional shape of the wiring main body of each inductor wiring 20 is not a rectangular shape.

Each wiring main body does not have a parallel part. Further, each specific distance may be equal to or greater than the width dimension of each corresponding parallel part.

The inductor wiring 20 may have only one of the parallel parts parallel to the long side of the main surface 11A and the parallel parts parallel to the short side of the main surface 11A. In this case, when the width dimension of the parallel part is greater than the corresponding specific distance, the effect can also be obtained that the DC resistance can be reduced and the inductance value can be improved.

It is preferable that the ratio between the width dimension of the parallel part and the specific distance corresponding to the parallel part is different for each parallel part. Accordingly, it is easy to design the width, length, and the like of the inductor wiring such that a preferable inductance value is obtained.

Only the first wiring main body 21LB of the first inductor wiring 21 may have the first parallel part 21PP. In other words, the second wiring main body 22LB of the second inductor wiring 22 does not have the second parallel part 22PP. In this case, also, in the inductor wiring 20 having parallel parts, the effect can be obtained that the DC resistance can be reduced and the inductance value can be improved.

In the four first parallel parts 21PP in the first wiring main body 21LB, in at least one first parallel part 21PP, the first specific distance SPL1 corresponding to the first parallel part 21PP may be less than the first width dimension which is a width dimension of the first parallel part 21PP. For example, for only one first parallel part 21PP, the first specific distance SPL1 corresponding to the first parallel part 21PP may be less than the first width dimension of the first parallel part 21PP. In this case, in the three first parallel parts 21PP excluding the first parallel part 21PP, the first specific distance SPL1 corresponding to each may be equal to or greater than the first width dimension of each of the three first parallel parts 21PP. In this case, also, in the inductor wiring 20 having parallel parts, the effect can be obtained that the DC resistance can be reduced and the inductance value can be improved. The same applies to the three second parallel parts 22PP in the second wiring main body 22LB.

The ratio between the first width dimension of the first parallel parts 21PP and the first specific distance SPL1 corresponding to the first parallel part 21PP may be the same as the ratio between the second width dimension of the second parallel part 22PP and the second specific distance SPL2 corresponding to the second parallel part 22PP.

The second parallel part 22PP is not present in the direction orthogonal to the main surface 11A with respect to the first parallel part 21PP. Even when the location of the parallel part is shifted in the first axis X direction, as long as each wiring main body has a parallel part having a width dimension greater than each specific distance, the effect can be obtained that the DC resistance can be reduced and the inductance value can be reduced.

When the second parallel part 22PP is present in the direction orthogonal to the main surface 11A with respect to the first parallel part 21PP, the first specific distance SPL1 corresponding to the first parallel part 21PP and the second specific distance SPL2 corresponding to the second parallel part 22PP may be different. Even when each of the specific distances is different in the direction orthogonal to the main surface 11A, when the width dimensions of each of the parallel parts are greater than each of the corresponding specific distances, the effect can be obtained that the DC resistance can be reduced and the inductance value can be improved.

Each of the first specific distances SPL1 corresponding to each of the first parallel parts 21PP may be different from each other. In addition, since each of the first specific distances SPL1 is different, it is easy to design the inductor wiring 20 such that a preferable inductance value is obtained.

There may be no location where the first inter-wiring distance is less than the first specific distance SPL1. Similarly, there may be no location where the second inter-wiring distance is less than the second specific distance SPL2. There may be no location where the third inter-wiring distance is less than the third specific distance SPL3.

There may be no location where the first inter-wiring distance is greater than the first specific distance SPL1. Similarly, there may be no location where the second inter-wiring distance is greater than the second specific distance SPL2. There may be no location where the third inter-wiring distance is greater than the third specific distance SPL3. As the inter-wiring distance decreases, the wiring length or cross-sectional area of the inductor wiring 20 is likely to increase.

### Regarding Support Wiring

As illustrated in FIG. 6, the inductor component 10 may include a support wiring 80 in the same layer as the inductor wiring 20. A first end 81A of the support wiring 80 is connected to the inductor wiring 20. Further, the second end 81B of the support wiring 80 is exposed on the side surface of the element body 11. The support wiring 80 is branched from the series path from the first outer electrode 31 to the second outer electrode 32 and is not connected to any other outer electrode. Therefore, the support wiring 80 does not contribute to the formation of the inductance of the inductor component 10. That is, the support wiring 80 is not included in the inductor wiring 20.

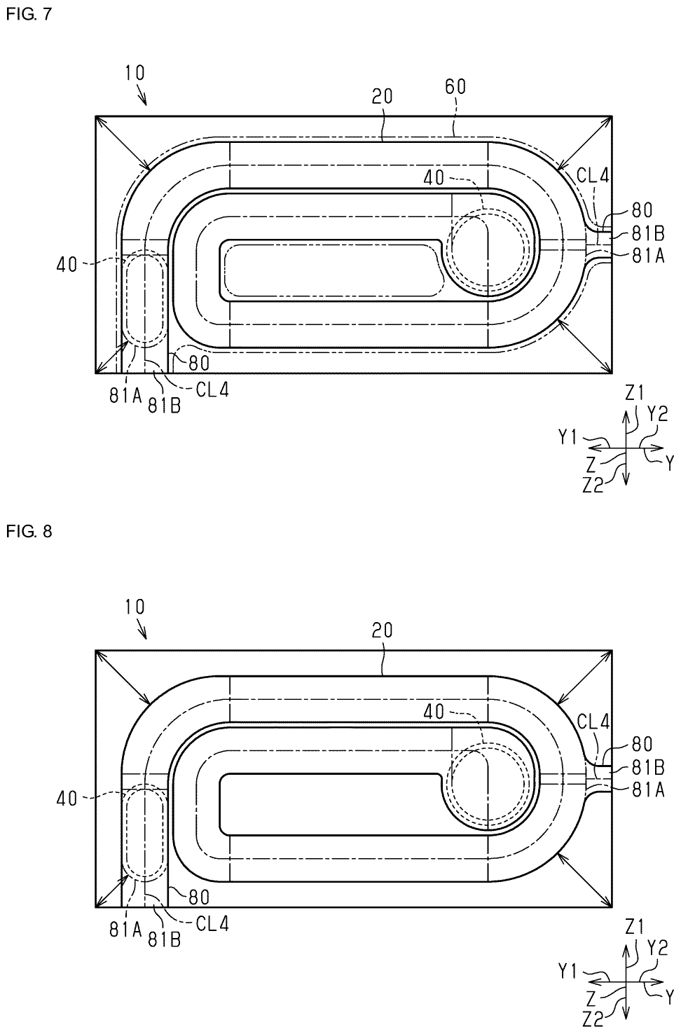

Further, as illustrated in FIG. 7, the inductor component 10 may include the plurality of support wirings 80. At this time, it is preferable that the second ends of the respective support wirings 80 are exposed on different side surfaces. For example, as illustrated in FIG. 7, the inductor component 10 may include two support wirings 80. In this case, the first end 81A of one support wiring 80 is connected to the pad portion of the inductor wiring 20. In addition, the second end 81B of one support wirings 80 is exposed on the side surface on the third negative direction Z2 side with respect to the geometric center of the element body 11. The first end 81A of the other support wiring 80 is connected to the wiring main body of the inductor wiring 20. In addition, the second end 81B of the other support wiring 80 is exposed on the side surface on the second negative direction Y2 side with respect to the geometric center of the element body 11.

According to the modification example, the support wiring 80 can be used as an energizing line for plating. Further, when forming the inductor component 10, it is possible to suppress the substrate from being distorted.

A dimension in the direction orthogonal to a center line CL4 of the support wiring 80 and parallel to the main surface 11A is defined as a width dimension. As illustrated in FIG. 6, the width dimension of the support wiring 80 may be the same as that of the inductor wiring 20. Further, as illustrated in FIG. 7, the width dimension of the support wiring 80 may be less than that of the inductor wiring 20 or does not have a certain size. The center line CL4 of the support wiring 80 is determined as follows. The shortest line segment is specified among line segments that can be drawn from any point on the edge of the support wiring 80 to the opposite edge thereof when viewed through in the first positive direction X1. A line connecting points passing through the centers of the specified line segments is defined as the center line of the support wiring 80 when viewed through in the first positive direction X1.

According to the modification example, by providing the plurality of support wirings 80, when forming the inductor component 10, it is easy to obtain the effect of suppressing distortion of the substrate.

The cross-sectional shape of the extension wiring is not limited to the example in the above-described embodiment. For example, as illustrated in FIG. 6, the cross section may have a circular columnar shape.

### Appendix

Technical ideas that can be derived from the above embodiment and modification examples will be described below.

[1] An inductor component including a rectangular parallelepiped element body containing a magnetic material and having a planar main surface; an inductor wiring extending parallel to the main surface in the element body; and a plurality of columnar wirings extending in a direction intersecting with the main surface. The inductor wiring includes a pair of pad portions which are positioned at both end portions of the inductor wiring, and to which the columnar wiring is connected, and a wiring main body which connects the pair of pad portions to each other. When the element body is viewed through in a direction orthogonal to the main surface, a specific pad portion, which is one of the pair of pad portions, is adjacent to an outer edge of the main surface without other parts of the inductor wiring therebetween, and when the element body is viewed through in the direction orthogonal to the main surface, and, among four corner portions of the main surface, the corner portion closest to the specific pad portion is defined as a specific corner portion, a shortest distance from the specific corner portion to an outer edge of the specific pad portion is less than a shortest distance from any corner portion excluding the specific corner portion to the wiring main body.

[2] The inductor component according to [1], in which the inductor wiring includes a first inductor wiring extending parallel to the main surface, and a second inductor wiring positioned at a different location from the first inductor wiring in the direction orthogonal to the main surface and extending parallel to the main surface. The first inductor wiring and the second inductor wiring are connected in series via the columnar wiring. In the element body, when the same layer as the first inductor wiring in the direction orthogonal to the main surface is defined as a first part and the same layer as the second inductor wiring in the direction orthogonal to the main surface is defined as a second part. Also, when the element body is viewed through in the direction orthogonal to the main surface, a shape of the first part and a shape of the second part match each other.

[3] The inductor component according to [1] or [2], in which the inductor wiring includes a first inductor wiring extending parallel to the main surface, and a second inductor wiring positioned at a different location from the first inductor wiring in the direction orthogonal to the main surface and extending parallel to the main surface. The first inductor wiring and the second inductor wiring are connected in series via the columnar wiring. The element body includes a first magnetic layer positioned on the main surface side with respect to the first inductor wiring, a second magnetic layer positioned in the same layer as the first inductor wiring and the second inductor wiring in the direction orthogonal to the main surface, a third magnetic layer positioned on a side opposite to the main surface with respect to the second inductor wiring, a first insulating layer laminated on a surface on the first inductor wiring side in the first magnetic layer, and a second insulating layer laminated on a surface of the first inductor wiring opposite to the first magnetic layer. The first inductor wiring is disposed on a surface of the first insulating layer opposite to the main surface, and the second inductor wiring is disposed on a surface of the second insulating layer opposite to the first inductor wiring. Also, when the element body is viewed through in the direction orthogonal to the main surface, an outer edge of the first insulating layer and an outer edge of the second insulating layer match each other.

[4] The inductor component according to any one of [1] to [3], in which the element body contains a magnetic powder, and in a particle size distribution of the magnetic powder, a median particle size (D50) is equal to or less than one tenth with respect to a shortest distance from the inductor wiring to the outer edge of the main surface when the element body is viewed through in the direction orthogonal to the main surface.

[5] The inductor component according to any one of [1] to [4], further including: a support wiring in the same layer as the inductor wiring in the direction orthogonal to the main surface, in which a first end of the support wiring is connected to the inductor wiring, and a second end of the support wiring is exposed on a side surface perpendicular to the main surface among outer surfaces of the element body.

[6] The inductor component according to [5], further including: the plurality of the support wirings, in which the second ends of the support wirings are exposed on the side surfaces different from each other.

[7] The inductor component according to any one of [1] to [6], in which the element body includes a first magnetic layer positioned on the main surface side with respect to the inductor wiring, a second magnetic layer positioned in the same layer as the inductor wiring in the direction orthogonal to the main surface, and a third magnetic layer positioned on a side opposite to the main surface with respect to the inductor wiring. The columnar wiring is positioned in the same layer as the third magnetic layer in the direction orthogonal to the main surface and is in contact with the third magnetic layer, a surface of the columnar wiring opposite to the main surface is exposed from the element body, and a dimension of the third magnetic layer in the direction orthogonal to the main surface is less than a dimension of the first magnetic layer in the direction orthogonal to the main surface.

[8] The inductor component according to any one of [1] to [7], in which the element body includes a first magnetic layer positioned on the main surface side with respect to the inductor wiring, a second magnetic layer positioned in the same layer as the inductor wiring in the direction orthogonal to the main surface, a third magnetic layer positioned on a side opposite to the main surface with respect to the inductor wiring, a first insulating layer disposed on a surface on the inductor wiring side in the first magnetic layer, a second insulating layer disposed on a surface of the inductor wiring opposite to the first magnetic layer, and a side surface insulating layer positioned in the same layer as the inductor wiring in the direction orthogonal to the main surface, the columnar wiring is positioned in the same layer as the third magnetic layer in the direction orthogonal to the main surface, and is in contact with the third magnetic layer, a surface of the columnar wiring opposite to the main surface is exposed from the element body, and the inductor wiring is not in contact with the first magnetic layer, the second magnetic layer, and the third magnetic layer.

[9] The inductor component according to any one of [1] to [8], in which the wiring main body includes a maximum point where a cross-sectional area of a cross section orthogonal to a center line of the wiring main body is the maximum and a minimum point where the cross-sectional area of the cross section orthogonal to the center line is the minimum, and the cross-sectional area at the maximum point is two or more times greater than the cross-sectional area at the minimum point.

[10] The inductor component according to any one of [1] to [9], in which, when viewed through in the direction orthogonal to the main surface, one or more selected from the plurality of the columnar wirings are connected to the inductor wiring at a location that does not overlap a center line of the inductor wiring.

[11] The inductor component according to any one of [1] to [10], in which the wiring main body has a parallel part extending parallel to a side of the main surface and adjacent to the side without interposing other parts of the inductor wiring therebetween, and when a dimension in the direction orthogonal to a center line of the wiring main body and parallel to the main surface in the wiring main body is defined as a width dimension, and a shortest distance from the side to the parallel part when viewed through in the direction orthogonal to the main surface is defined as a specific distance, the specific distance is less than the width dimension of the parallel part.

What is claimed is:

1. An inductor component comprising:
a rectangular parallelepiped element body containing a magnetic material and having a planar main surface;
an inductor wiring extending parallel to the main surface in the element body; and
a plurality of columnar wirings extending in a direction intersecting with the main surface, wherein
the inductor wiring includes a pair of pad portions which are at both end portions of the inductor wiring, and to which the columnar wiring is connected, and a wiring main body which connects the pair of pad portions to each other,
when the element body is viewed through in a direction orthogonal to the main surface, a specific pad portion, which is one of the pair of pad portions, is adjacent to an outer edge of the main surface without other parts of the inductor wiring therebetween, and
a specific corner portion is defined as the corner portion closest to the specific pad portion among four corner portions of the main surface when the element body is viewed through in the direction orthogonal to the main surface,
a shortest distance from the specific corner portion to an outer edge of the specific pad portion is less than a shortest distance from any corner portion excluding the specific corner portion to the wiring main body.

2. The inductor component according to claim 1, wherein
the inductor wiring includes
a first inductor wiring extending parallel to the main surface, and
a second inductor wiring at a different location from the first inductor wiring in the direction orthogonal to the main surface and extending parallel to the main surface,
the first inductor wiring and the second inductor wiring are connected in series via the columnar wiring, and
in the element body, when the same layer as the first inductor wiring is in the direction orthogonal to the main surface is defined as a first part, and the same layer as the second inductor wiring is in the direction orthogonal to the main surface is defined as a second part, and
when the element body is viewed through in the direction orthogonal to the main surface,
a shape of the first part and a shape of the second part match each other.

3. The inductor component according to claim 1, wherein
the inductor wiring includes
a first inductor wiring extending parallel to the main surface, and
a second inductor wiring at a different location from the first inductor wiring in the direction orthogonal to the main surface and extending parallel to the main surface,
the first inductor wiring and the second inductor wiring are connected in series via the columnar wiring,
the element body includes
a first magnetic layer on the main surface side with respect to the first inductor wiring,
a second magnetic layer in the same layer as the first inductor wiring and the second inductor wiring in the direction orthogonal to the main surface,
a third magnetic layer on a side opposite to the main surface with respect to the second inductor wiring,
a first insulating layer laminated on a surface of the first magnetic layer on the first inductor wiring side, and
a second insulating layer laminated on a surface of the first inductor wiring opposite to the first magnetic layer,
the first inductor wiring is on a surface of the first insulating layer opposite to the main surface,
the second inductor wiring is on a surface of the second insulating layer opposite to the first inductor wiring, and
when the element body is viewed through in the direction orthogonal to the main surface, an outer edge of the first insulating layer and an outer edge of the second insulating layer match each other.

4. The inductor component according to claim 1, wherein
the element body contains a magnetic powder, and
in a particle size distribution of the magnetic powder, a median particle size (D50) is equal to or less than one tenth with respect to a shortest distance from the inductor wiring to the outer edge of the main surface when the element body is viewed through in the direction orthogonal to the main surface.

5. The inductor component according to claim 1, further comprising:
a support wiring in the same layer as the inductor wiring in the direction orthogonal to the main surface, wherein
a first end of the support wiring is connected to the inductor wiring, and
a second end of the support wiring is exposed on a side surface perpendicular to the main surface among outer surfaces of the element body.

6. The inductor component according to claim 5, further comprising:
the plurality of the support wirings, wherein
the second ends of the support wirings are exposed on the different side surfaces from each other.

7. The inductor component according to claim 1, wherein
the element body includes
a first magnetic layer on the main surface side with respect to the inductor wiring,
a second magnetic layer in the same layer as the inductor wiring in the direction orthogonal to the main surface, and
a third magnetic layer on a side opposite to the main surface with respect to the inductor wiring,
the columnar wiring is in the same layer as the third magnetic layer in the direction orthogonal to the main surface and is in contact with the third magnetic layer,
a surface of the columnar wiring opposite to the main surface is exposed from the element body, and
a dimension of the third magnetic layer in the direction orthogonal to the main surface is less than a dimension of the first magnetic layer in the direction orthogonal to the main surface.

8. The inductor component according to claim 1, wherein
the element body includes
a first magnetic layer on the main surface side with respect to the inductor wiring,
a second magnetic layer in the same layer as the inductor wiring in the direction orthogonal to the main surface,
a third magnetic layer on a side opposite to the main surface with respect to the inductor wiring,
a first insulating layer on a surface of the first magnetic layer on the inductor wiring side,
a second insulating layer on a surface of the inductor wiring opposite to the first magnetic layer, and
a side surface insulating layer in the same layer as the inductor wiring in the direction orthogonal to the main surface,
the columnar wiring is in the same layer as the third magnetic layer in the direction orthogonal to the main surface, and is in contact with the third magnetic layer,
a surface of the columnar wiring opposite to the main surface is exposed from the element body, and
the inductor wiring is not in contact with the first magnetic layer, the second magnetic layer, and the third magnetic layer.

9. The inductor component according to claim 1, wherein
the wiring main body includes a maximum point where a cross-sectional area of a cross section orthogonal to a center line of the wiring main body is the maximum and a minimum point where the cross-sectional area of the cross section orthogonal to the center line is the minimum, and
the cross-sectional area at the maximum point is two or more times greater than the cross-sectional area at the minimum point.

10. The inductor component according to claim 1, wherein
when viewed through in the direction orthogonal to the main surface, one or more selected from the plurality of the columnar wirings are connected to the inductor wiring at a location that does not overlap a center line of the inductor wiring.

11. The inductor component according to claim 1, wherein
the wiring main body has a parallel part extending parallel to a side of the main surface of the element body and adjacent to the side without interposing other parts of the inductor wiring therebetween, and
when a width dimension is defined as a dimension of the parallel part in the direction orthogonal to a center line of the wiring main body and parallel to the main surface in the wiring main body, and a specific distance is defined as a shortest distance from the side to the parallel part when viewed through in the direction orthogonal to the main surface, the specific distance is less than the width dimension of the parallel part.
